(19) United States
(12) Patent Application Publication
(10) Pub. No.: US 2016/0349870 A1
(43) Pub. Date: Dec. 1, 2016

(54) Self Capacitance Type Touch Panel and Conductive Layer Structure Thereof

(71) Applicant: SHENZHEN CHINA STAR OPTOELECTRONICS TECHNOLOGY CO., LTD., Shenzhen City, Guangdong (CN)

(72) Inventor: Chun-kai CHANG, Shenzhen, Guangdong (CN)

(73) Assignee: Shenzhen China Star Optoelectronics Technology Co., Ltd., Shenzhen, Guangdong (CN)

(21) Appl. No.: 14/408,856

(22) PCT Filed: Dec. 9, 2014
(86) PCT No.: PCT/CN2014/093352

§ 371 Date: Dec. 17, 2014

(30) Foreign Application Priority Data
Dec. 5, 2014 (CN) 201410737126.7

(51) Int. Cl. G06F 3/044

(52) U.S. Cl. CPC G06F 3/044; G06F 2203/04104

(57) ABSTRACT

The present invention discloses a self capacitance type touch panel and the conductive layer structure thereof. The conductive layer structure comprises multiple rectangular first electrode patterns, multiple rectangular second electrode patterns, multiple rectangular third electrode patterns, and multiple outer wirings connected correspondingly to the first rectangular electrode, the second rectangular electrode, and the third rectangular electrode. The second electrode patterns are arranged with an interval, and the first electrode pattern and the third electrode pattern between two adjacent rows of the second electrode patterns are alternately arranged along the row direction. Through the above way, the present invention can determine the real touch point accurately and is beneficial for the liquid crystal display (LCD) panel design with narrow border or without border.

### BACKGROUND OF THE INVENTION

1. Field of the Invention

The invention relates to technical field of touch screen, and specifically relates to a conductive layer structure and a self capacitance type touch panel with the conductive layer structure thereof.

2. The Related Arts

The work principle of self capacitance type touch technology is to form capacitive coupling between the conductive layer structure and finger or other touch object, and by detecting the capacitance change on the conductive layer structure to ensure the touch event. In multi-touch technology, how to determinate the Ghost point to determinate the real touch point accurately, is the industry's urgent problems to be solved.

### SUMMARY OF THE INVENTION

The technical problem to be solved by the embodiment of the present invention is to provide a self capacitance type touch panel and the conductive layer structure thereof, which can determinate the real touch point accurately.

An aspect of the present invention is to provide a conductive layer structure, comprising: multiple rectangular first electrode patterns, multiple rectangular second electrode patterns, multiple rectangular third electrode patterns, and multiple outer wirings connected correspondingly to the first rectangular electrode, the second rectangular electrode, and the third rectangular electrode; the third electrode patterns being arranged with an interval, and the first electrode pattern and the second electrode pattern, between two adjacent rows of the third electrode patterns being alternately arranged along the row direction, wherein, the second electrode patterns at the same row connect to the same outer wiring; the conductive layer structure further comprises multiple signal wirings electrically connected to the first electrode pattern, the second electrode pattern, and the third electrode pattern respectively, and the first electrode pattern, the second electrode pattern, and the third electrode pattern are connected to the outer wirings through the signal wirings; the conductive layer structure further comprises multiple series wirings, used to connect to the first electrode pattern at the same column, so that the first electrode patterns at the same column are able to connect to the same outer wiring.

Wherein, the outer wiring connected to the first electrode pattern is arranged along the row direction and parallel to the outer wiring connected to the second electrode pattern with an interval.

Wherein, the conductive layer further comprises an auxiliary electrode pattern, the auxiliary electrode pattern is arranged at the edge outside the coverage area of the first electrode pattern and the second electrode pattern.

Wherein, the auxiliary electrode pattern is a rectangular electrode pattern.

Another aspect of the present invention is to provide a conductive layer structure, comprising: multiple rectangular first electrode patterns, multiple rectangular second electrode patterns, multiple rectangular third electrode patterns, and multiple outer wirings connected correspondingly to the first rectangular electrode, the second rectangular electrode, and the third rectangular electrode; the third electrode patterns being arranged with an interval, and the first electrode pattern and the second electrode pattern located between two adjacent rows of the third electrode patterns being alternately arranged along the row direction.

Wherein, the second electrode patterns at the same row connect to the same outer wiring.

Wherein, the conductive layer structure further comprises multiple series wirings, which are used to connect to the first electrode pattern at the same column, so that the first electrode patterns at the same column are able to connect to the same outer wiring.

Wherein, the outer wiring connected to the first electrode pattern is arranged along the row direction and parallel to the outer wiring connected to the second electrode pattern with an interval.

Wherein, the conductive layer structure further comprises multiple series wirings, used to connect to the first electrode pattern in the same row, so that the first electrode patterns in the same row are able to connect to the same outer wiring.

Wherein, the outer wiring connected to the first electrode pattern is arranged along the column direction and vertical to the outer wiring connected to the second electrode pattern.

Wherein, the conductive layer structure further comprises multiple signal wirings electrically connected to the first electrode pattern, the second electrode pattern, and the third electrode pattern respectively, and the first electrode pattern, the second electrode pattern, and the third electrode pattern are connected to the outer wirings through the signal wirings.

Wherein, the conductive layer further comprises an auxiliary electrode pattern, the auxiliary electrode pattern is arranged at the edge outside the coverage area of the first electrode pattern and the second electrode pattern.

Wherein, the auxiliary electrode pattern is a rectangular electrode pattern.

Another aspect of the present invention is to provide a self capacitance type touch panel, comprising: a signal detector, a processor, and a conductive layer structure; the signal detector is connected to multiple outer wirings, so that a capacitive touch signal in column and row direction is able to be detected; the processor being connected to the signal detector, so that a touch point in a multi-touch event is able to be judged according to the capacitive touch signal; the conductive layer structure comprising multiple rectangular first electrode patterns, multiple rectangular second electrode patterns, multiple rectangular third electrode patterns, and multiple outer wirings connected correspondingly to the first rectangular electrode, the second rectangular electrode, and the third rectangular electrode; the third electrode patterns being arranged with an interval, and the first electrode pattern and the second electrode pattern located between two adjacent rows of the third electrode patterns being alternately arranged along the row direction.

Wherein, the second electrode patterns in the same row connect to the same outer wiring.

Wherein, the conductive layer structure further comprises multiple series wirings, used to connect to the first electrode pattern at the same column, so that the first electrode patterns at the same column are able to connect to the same outer wiring.

Wherein, the outer wiring connected to the first electrode pattern is arranged along the row direction and parallel to the outer wiring connected to the second electrode pattern with an interval.

Wherein, the conductive layer structure further comprises multiple series wirings, used to connect to the first electrode pattern in the same row, so that the first electrode patterns in the same row are able to connect to the same outer wiring.

Wherein, the outer wiring connected to the first electrode pattern is arranged along the column direction and vertical to the outer wiring connected to the second electrode pattern.

Wherein, the conductive layer structure further comprises multiple signal wirings electrically connected to the first electrode pattern, the second electrode pattern, and the third electrode pattern respectively, and the first electrode pattern, the second electrode pattern, and the third electrode pattern are connected to the outer wirings through the signal wirings.

Through the above technical scheme, the beneficial effects of the embodiment of the invention are as follows.

The embodiment of the present invention is to design a conductive layer structure comprising multiple rectangular first electrode patterns, multiple rectangular second electrode patterns, multiple rectangular third electrode patterns, wherein: the second electrode patterns are arranged with an interval, and the first electrode pattern and the third electrode pattern, between two adjacent rows of the second electrode patterns, are alternately arranged along the row direction. By detecting the capacitance change at column and row direction corresponding to the first electrode pattern, second electrode pattern, and third electrode pattern, the positions of the real touch point and ghost point are able to be determined.

### BRIEF DESCRIPTION OF THE DRAWINGS

FIG. 1 is the first schematic diagram of the conductive layer structure according to the first embodiment of present invention;

FIG. 2 is the second schematic diagram of the conductive layer structure according to the first embodiment of present invention;

FIG. 3 is the schematic diagram of the first working principle for the conductive layer structure according to the first embodiment of present invention;

FIG. 4 is the schematic diagram of the second working principle for the conductive layer structure according to present invention;

FIG. 5 is the schematic diagram of the conductive layer structure according to the second embodiment of the present invention.

### DETAILED DESCRIPTION OF THE PREFERRED EMBODIMENTS

In the following embodiments of the invention in conjunction with the accompanying drawings, embodiments of the present invention, the technical solutions clearly and completely described, obviously, the described embodiments are only part of the embodiments of the present invention, but not all of the implementation of the case. Based on the embodiment of the present invention, persons of ordinary skill in the art without creative efforts obtained under the premise that all other embodiments, all belong to the protection scope of the present invention.

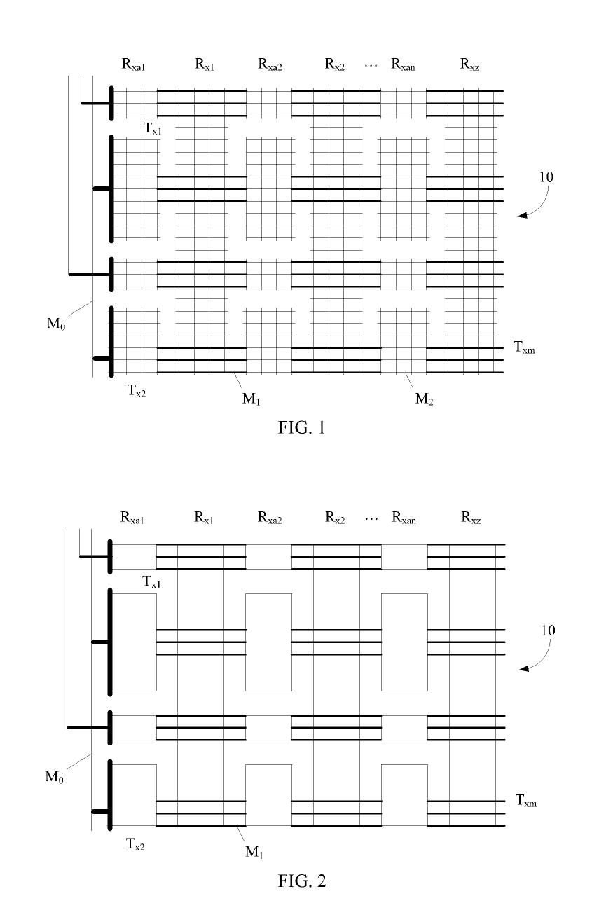

Referring to FIGS. 1 and 2, the conductive layer structure 10 in present embodiment, is arranged on the surface of the substrate made from glass or thin film material, comprising multiple rectangular first electrode patterns Rₓₐ₁, Rₓₐ₂ Rₓₙ, multiple rectangular second electrode patterns Tₓ₁,Tₓ₂, Tₓₘ, multiple rectangular third electrode patterns Rₓ₁,Rₓ₂ R_{xz}, and multiple outer wirings M₀ connected correspondingly to the first rectangular electrode Rₓₐ₁, Rₓₐ₂, Rₓₐ₃, Rₓ, the second rectangular electrode Tₓ₁,Tₓ₂ Tₓₘ, and the third rectangular electrode Rₓ₁,Rₓ₂ R_{xz}.

A plurality of first electrode pattern Rₓₐ₁, Rₓₐ₂ Rₓₙ are arranged in a matrix, a plurality of third electrode pattern Rₓ₁, Rₓ₂ R_{xz} are also arranged in a matrix, a plurality of striped third electrode pattern Rₓ₁, Rₓ₂ R_{xz} are arranged parallel to each other with an interval, and the first electrode pattern and the second electrode pattern, between two adjacent rows of the third electrode patterns, are alternately arranged along the row direction.

Referring to FIG. 1, the conductive layer structure 10 further comprises multiple signal wirings M₂ electrically connected to the first electrode pattern Rₓₐ₁,Rₓₐ₂,Rₓₐ₃, Rₓₙ, the second electrode pattern Tₓ₁,Tₓ₂, Tₓₘ, and the third electrode pattern Rₓ₁,Rₓ₂, R_{xz} respectively, and the first electrode pattern Rₓₐ₁,Rₓₐ₂, Rₓₐ₃, Rₓₙ, the second electrode pattern Tₓ₁,Tₓ₂, Tₓₘ, and the third electrode pattern Rₓ₁,Rₓ₂, R_{xz} are connected to the outer wiring M₀ with the signal wiring M₂.

The second electrode patterns at the same row connect to the same outer wiring M₀. In a preferred embodiment, the conductive layer structure 10 further comprises multiple series wirings M₁ arranged along the column direction, and the series wiring M₁ is used to connect to the second electrode pattern at the same column in series, so that the width of the wiring area is able to be reduced, which is beneficial for the liquid crystal display (LCD) panel design with narrow border or without border.

The first electrode patterns at the same column are connected with series wiring M₁, to connect to the same outer wiring M₀, but the first electrode patterns in the same row connect different outer wiring M₀.

Wherein, the series wiring M₁ connected to two adjacent first electrode patterns in a column steps over the third electrode pattern, and the series wiring M₁ is insulated from the corresponding third electrode pattern; the series wiring M₁ connected to two adjacent second electrode patterns in a column steps over the third electrode pattern, and the series wiring M₁ is insulated from the corresponding third electrode pattern.

In present embodiment, the outer wiring M₀ connected to the first electrode pattern Rₓₐ₁, Rₓₐ₂, Rₓₐ₃, Rₓₙ, is arranged along the row direction, and the outer wiring M₀ connected to the second electrode pattern Tₓ₁, Tₓ₂, Tₓₘ, is also arranged along the row direction, they are arranged parallel to each other with an interval.

In a preferred embodiment, the first electrode pattern Rₓₐ₁,Rₓₐ₂,Rₓₐ₃ Rₓₙ, the second electrode pattern Tₓ₁,Tₓ₂, Tₓₘ, and the third electrode pattern Rₓ₁,Rₓ₂ R_{xz} are made from ITO (Indium Tin Oxide), and they construct commonly a plurality of the sensor unit of the conductive layer structure 10.

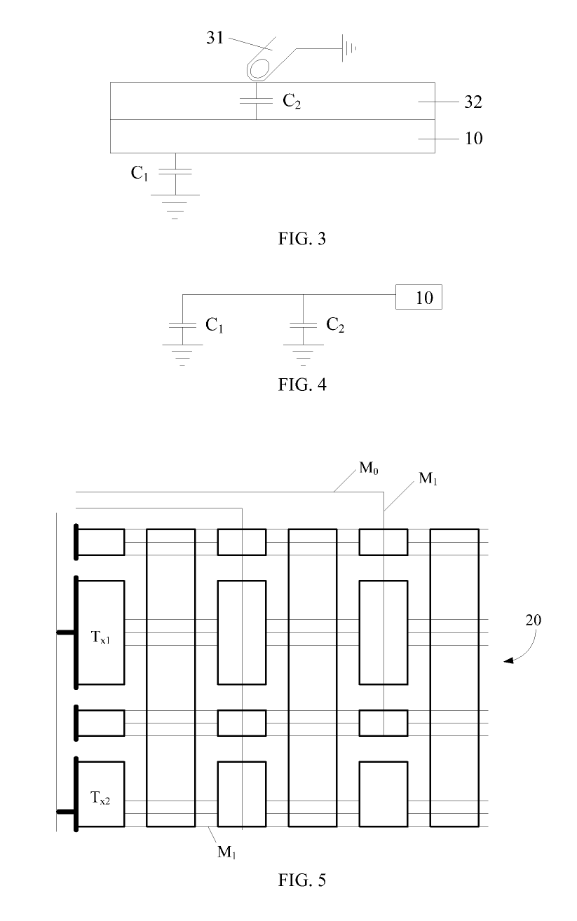

Please further referring to FIG. 3, the first electrode pattern and the second electrode pattern and ground respectively construct a self-capacitance C₁ to ground. As a finger 31 touches the cover plate 32, a capacitance C₂ is formed because the human body can be equivalent to ground, between the finger 31 and the first electrode pattern or the second electrode pattern. The capacitance C₁ and the capacitance C₂ construct the parallel circuit as shown in FIG. 4, so that the capacitance of the corresponding sensor unit is able to increase. Based on this, the touch event occurring can be judged by detecting the capacitance change of each sensor unit, and the touch point position is able to be determined with the coordinate information of the first electrode pattern and the second electrode pattern on touch panel.

Referring to FIG. 2 again, any change of the capacitance corresponding to the adjacent first electrode pattern and second electrode pattern, and the area ratio of the touch point corresponding to the first electrode pattern and the second electrode pattern, can be used to calculate the coordinate of the touch point in the row direction. Similarly, any change of the capacitance corresponding to the adjacent third electrode pattern and second electrode pattern or first electrode pattern, and the area ratio of the touch point corresponding to the third electrode pattern and the second electrode pattern or first electrode pattern, can be used to calculate the coordinate of the touch point in the column direction.

The present invention further discloses a conductive layer structure in second embodiment, which is different from the conductive layer structure 10 in first embodiment with the series wiring M₁ being arranged along row direction, and the outer wiring M₀ corresponding to the first electrode pattern being arranged along the column direction, in the conductive layer structure 20 in present embodiment.

Referring to FIG. 5, multiple series wirings M₁ series connect to the first electrode pattern in the same row, so that the first electrode patterns in the same row are able to connect to the same outer wiring M₀, and the outer wiring M₀ connected to the first electrode pattern is arranged along the column direction and vertical to the outer wiring M₀ connected to the second electrode pattern.

Wherein, the series wiring M₁ connected to two adjacent first electrode patterns in a row steps over the second electrode pattern, and the series wiring M₁ is insulated from the corresponding second electrode pattern.

The primary object of the present invention is to design a conductive layer structure comprising multiple rectangular first electrode patterns, multiple rectangular second electrode patterns, multiple rectangular third electrode patterns, wherein: the second electrode patterns are arranged at an interval, and the first electrode pattern and the third electrode pattern, between two adjacent rows of the second electrode patterns, are alternately arranged along the row direction. By detecting the capacitance change at column and row direction corresponding to the first electrode pattern, second electrode pattern, and third electrode pattern, the position of the real touch point is able to be determined.

In this manner, the conductive layer structure in present invention further provide other arrangement, e.g., the conductive layer structure further comprises an auxiliary electrode pattern which is preferred rectangle, and the auxiliary electrode pattern is arranged at the edge outside the coverage area of the first electrode pattern, the second electrode pattern, and the third electrode pattern, which means that auxiliary electrode pattern is arranged at the edge of the coverage area of electrode pattern as shown in FIG. 1 and FIG. 2. As the finger touch the edge of the region, the touch region area on the auxiliary electrode pattern is able to compensate the loss area of the coverage area of electrode, as well as reducing the coordinate offset at the edge of touch screen, which is able to improve the drift phenomenon at the edge of touch screen.

The present invention further discloses a self capacitance type touch panel, comprising: a signal detector, a processor, and a conductive layer structure in aforementioned embodiment (including conductive layer structure 10 and 20). Wherein, the signal detector is connected to multiple outer wirings, so that a capacitive touch signal in column and row direction is able to be detected; the processor is connected to the signal detector, so that a touch point in a multi-touch event is able to be judged according to the capacitive touch signal.

Finally, it must be noted again that the above described embodiments of the invention only, and not limit the patent scope of the present invention, therefore, the use of all the contents of the accompanying drawings and the description of the present invention is made to equivalent structures or equivalent conversion process, e.g., between the embodiments Example technology mutually binding characteristics, directly or indirectly related to the use of technology in other fields, are included within the scope of patent empathy protection of the invention.

What is claimed is:

1. A conductive layer structure, comprising: multiple rectangular first electrode patterns, multiple rectangular second electrode patterns, multiple rectangular third electrode patterns, and multiple outer wirings connected correspondingly to the first rectangular electrode, the second rectangular electrode, and the third rectangular electrode; the third electrode patterns being arranged with an interval, and the first electrode pattern and the second electrode pattern located between two adjacent rows of the third electrode patterns being alternately arranged along the row direction;
wherein, the second electrode patterns at the same row connect to the same outer wiring; the conductive layer structure further comprises multiple signal wirings electrically connected to the first electrode pattern, the second electrode pattern, and the third electrode pattern respectively, and the first electrode pattern, the second electrode pattern, and the third electrode pattern are connected to the outer wirings through the signal wirings; the conductive layer structure further comprises multiple series wirings, which are used to connect to the first electrode pattern at the same column, so that the first electrode patterns at the same column are able to connect to the same outer wiring.

2. The conductive layer structure as claimed in claim 1, wherein the outer wiring connected to the first electrode pattern is arranged along the row direction and parallel to the outer wiring connected to the second electrode pattern with an interval.

3. The conductive layer structure as claimed in claim 1, wherein the conductive layer further comprises an auxiliary electrode pattern, the auxiliary electrode pattern is arranged at the edge outside the coverage area of the first electrode pattern and the second electrode pattern.

4. The conductive layer structure as claimed in claim 3, wherein the auxiliary electrode pattern is a rectangular electrode pattern.

5. A conductive layer structure, comprising: multiple rectangular first electrode patterns, multiple rectangular second electrode patterns, multiple rectangular third electrode patterns, and multiple outer wirings connected correspondingly to the first rectangular electrode, the second rectangular electrode, and the third rectangular electrode; the third electrode patterns being arranged with an interval, and the first electrode pattern and the second electrode pattern located between two adjacent rows of the third electrode patterns being alternately arranged along the row direction.

6. The conductive layer structure as claimed in claim 5, wherein the second electrode patterns at the same row connect to the same outer wiring.

7. The conductive layer structure as claimed in claim 5, wherein the conductive layer structure further comprises multiple series wirings, which are used to connect to the first electrode pattern at the same column, so that the first electrode patterns at the same column are able to connect to the same outer wiring.

8. The conductive layer structure as claimed in claim 7, wherein the outer wiring connected to the first electrode pattern is arranged along the row direction and parallel to the outer wiring connected to the second electrode pattern with an interval.

9. The conductive layer structure as claimed in claim 5, wherein the conductive layer structure further comprises multiple series wirings, used to connect to the first electrode pattern in the same row, so that the first electrode patterns in the same row are able to connect to the same outer wiring.

10. The conductive layer structure as claimed in claim 9, wherein the outer wiring connected to the first electrode pattern is arranged along the column direction and vertical to the outer wiring connected to the second electrode pattern.

11. The conductive layer structure as claimed in claim 5, wherein the conductive layer structure further comprises multiple signal wirings electrically connected to the first electrode pattern, the second electrode pattern, and the third electrode pattern respectively, and the first electrode pattern, the second electrode pattern, and the third electrode pattern are connected to the outer wirings through the signal wirings.

12. The conductive layer structure as claimed in claim 5, wherein the conductive layer further comprises an auxiliary electrode pattern, the auxiliary electrode pattern is arranged at the edge outside the coverage area of the first electrode pattern and the second electrode pattern.

13. The conductive layer structure as claimed in claim 12, wherein the auxiliary electrode pattern is a rectangular electrode pattern.

14. A self capacitance type touch panel, comprising: a signal detector, a processor, and a conductive layer structure; the signal detector is connected to multiple outer wirings, so that a capacitive touch signal in column and row direction is able to be detected; the processor being connected to the signal detector, so that a touch point in a multi-touch event is able to be judged according to the capacitive touch signal; the conductive layer structure comprising multiple rectangular first electrode patterns, multiple rectangular second electrode patterns, multiple rectangular third electrode patterns, and multiple outer wirings connected correspondingly to the first rectangular electrode, the second rectangular electrode, and the third rectangular electrode; the third electrode patterns being arranged with an interval, and the first electrode pattern and the second electrode pattern located between two adjacent rows of the third electrode patterns being alternately arranged along the row direction.

15. The self capacitance type touch panel as claimed in claim 14, wherein the second electrode patterns in the same row connect to the same outer wiring.

16. The self capacitance type touch panel as claimed in claim 14, wherein the conductive layer structure further comprises multiple series wirings, used to connect to the first electrode pattern at the same column, so that the first electrode patterns at the same column are able to connect to the same outer wiring.

17. The self capacitance type touch panel as claimed in claim 15 and claim 16, wherein the outer wiring connected to the first electrode pattern is arranged along the row direction and parallel to the outer wiring connected to the second electrode pattern with an interval.

18. The self capacitance type touch panel as claimed in claim 1, wherein the conductive layer structure further comprises multiple series wirings, used to connect to the first electrode pattern in the same row, so that the first electrode patterns in the same row are able to connect to the same outer wiring.

19. The self capacitance type touch panel as claimed in claim 18, wherein the outer wiring connected to the first electrode pattern is arranged along the column direction and vertical to the outer wiring connected to the second electrode pattern.

20. The self capacitance type touch panel as claimed in claim 14, wherein the conductive layer structure further comprises multiple signal wirings electrically connected to the first electrode pattern, the second electrode pattern, and the third electrode pattern respectively, and the first electrode pattern, the second electrode pattern, and the third electrode pattern are connected to the outer wirings through the signal wirings.
